(19) United States
(12) Patent Application Publication
(10) Pub. No.: US 2010/0278971 A1
(43) Pub. Date: Nov. 4, 2010

(54) Preparation Method of Vegetable Extract Ferment Solution and Vegetable Extract Ferment Solution Prepared by the Same

(75) Inventors: Min Seok Song, Seoul (KR); Kyong Hyun Sohn, Gyeonggi-do (KR); Kang Pyo Lee, Seoul (KR); Sang keun Suh, Gyeonggi-do (KR); Wonil Cho, Seoul (KR)

Correspondence Address: STERNE, KESSLER, GOLDSTEIN & FOX P.L.L.C., 1100 NEW YORK AVENUE, N.W., WASHINGTON, DC, 20005, US

(73) Assignee: CJ Cheiljedang Corporation, Seoul (KR)

(21) Appl. No.: 12/678,531

(22) PCT Filed: Sep. 26, 2008
(86) PCT No.: PCT/KR2008/005724

§ 371 Date: Jun. 30, 2010

(30) Foreign Application Priority Data
Sep. 28, 2007 (KR) 10-2007-0097880

(51) Int. Cl. A23L 1/28; A23L 1/314

(52) U.S. Cl. 426/51; 426/655; 426/641

(57) ABSTRACT

The present invention relates to a preparation method of vegetable extract fermented solution and a vegetable extract fermented solution prepared by the same. The vegetable extract fermented solution prepared from nitrate-containing vegetables according to the present invention is used for the production of meat products to improve characteristic meat color and inhibit lipid oxidation without using synthetic nitrite.

### TECHNICAL FIELD

The present invention relates to a preparation method of vegetable extract fermented solution and a vegetable extract fermented solution prepared by the same.

### BACKGROUND ART

In general, synthetic nitrite is added in the production process of meat products such as ham and sausage in order to stabilize the color of the meat (fix its pink color), to inhibit growth of bacteria which cause food poisoning and spoilage, and to improve storage stability. Synthetic nitrite reacts with the meat pigments, myoglobin and hemoglobin to form nitrosomyoglobin and nitrosohemoglobin. Thus, it functions to fix the color of meat, to impart a unique flavor to cured meat, and to inhibit growth of bacteria.

Synthetic nitrite has advantages in its function, but excessive ingestion of synthetic nitrite may lead to the formation of carcinogenic nitrosoamines by its accumulation or induce infantile methemoglobinemia. In view of the possible risk of toxicity and carcinogenesis, the amount of nitrite added to foods is progressively being restricted. In Korea and Japan, the residual nitrite level in the final products is restricted to 70 ppm or less, and in most countries including England and Germany, it is also restricted to 10˜200 ppm.

Thus, many studies have attempted to eliminate synthetic nitrite in the production process of meat products; a specific substance is added to the product to reduce the residual nitrite level, or synthetic nitrite is replaced by other substances.

There are methods for reducing the residual nitrite level in meat products, such as those that follow. Since synthetic nitrite in meat products is affected by pH or temperature, its residual level can be reduced to some degree by lowering pH or heating temperature. In addition, the increased concentration of sodium chloride can lower the residual nitrite. It was published that the addition of ascorbate, potassium nitrate, sodium nitrate, lactic acid bacteria, alpha tocopherol, potassium sorbate, flavonoid compounds, caffeic acid, ferulic acid, or various phenolic compounds can reduce the residual nitrite during the production process of meat products. However, these additives are problematic in that their excessive use is also restricted, excessively costly, and methods and technologies for adding them are also limited.

To solve the above problems, Korean Patent No. 10-308387 discloses a method for inhibiting lipid oxidation and lessening contents of nitrite in meat products, in which conjugated linoleic acid is added during the production process of meat products.

As a technology to ensure that the characteristic flavor and safety is identical to those of the known meat products without adding synthetic nitrite, Korean Patent Publication No. 10-2006-17659 discloses a method of color development in meat products in which nitric oxide is added, instead of nitrite, in order to fix the meat pigmentation. In this method, nitric oxide generated by using a nitric oxide-generating device is reacted with the meat pigment myoglobin, resulting in the color fixation of meat pigments. However, since this method is an ionization technology using nitrite, ascorbic acid, nitric acid or the like, synthetic nitrite is also used as a raw material.

In addition, Korean Patent Publication No. 10-2001-88698 discloses a method using chitosan as an alternative to nitrite or nitrate, in particular, a technology that replaces nitrite with chitosan or a derivative thereof, which is obtained by the deacetylation of chitin found in shrimp or crab shells, cuttlefish bones, and shellfish, for color development.

As mentioned above, there is no development of viable alternatives to nitrites, which can exhibit the effect of fixing characteristic meat color, inhibit growth of bacteria, and improve storage stability. Accordingly, there is an urgent need for the development of alternatives to nitrite.

### DISCLOSURE

### Technical Problem

Accordingly, the present inventors have made intensive studies on alternatives to nitrites, looking for an alternative which is capable of exhibiting the effect of fixing characteristic meat color, inhibiting growth of bacteria, and improving storage stability. They found that a vegetable extract fermented solution prepared by mixing a vegetable extract with nitrate-reducing bacterium can be used in the production of meat products to improve characteristic meat color and flavor and inhibit lipid oxidation, thereby completing the present invention.

### Technical Solution

The present invention provides a preparation method of a vegetable extract fermented solution and a vegetable extract fermented solution prepared by the same.

### DESCRIPTION OF DRAWINGS

FIG. 1 shows the production process of meat products using the vegetable extract fermented solution according to the present invention;

FIG. 2 shows the color of vienna sausages prepared by using the vegetable extract fermented solution according to the present invention; and

FIG. 3 shows the result of TBA analysis of vienna sausages prepared by using the vegetable extract fermented solution according to the present invention.

### BEST MODE

The present invention provides a preparation method of vegetable extract fermented solution, comprising the steps of:

1) washing and squeezing vegetables, and then performing filtration, heat-treatment and heat-sterilization of the vegetable juice,

2) mixing the heat-sterilized vegetable juice with maltitol and dextrose, and then spray-drying the mixture to obtain a vegetable extract; and

3) mixing the vegetable extract with drinking water, adding nitrate-reducing bacterium thereto, mixing/spraying it, and performing fermentation and cooling thereof.

Further, the present invention provides a vegetable extract fermented solution prepared by the above preparation method.

Hereinbelow, the present invention will be described in detail.

The vegetables used in the present invention include carrot, celery, cabbage, lettuce, spinach, potato, radish, and sugar beet, and the nitrate contents in the vegetables are as follows: 18˜600 ppm in carrot, 356˜3,530 ppm in celery, 35˜580 ppm in cabbage, 396˜3,550 ppm in lettuce, 308˜3,784 ppm in spinach, 39˜119 ppm in potato, 528˜3,520 ppm in radish, and 682˜8,008 ppm in sugar beet.

The nitrates-containing vegetables are washed with water, and squeezed out, followed by filtration. For enzyme deactivation, the filtrate is subjected to heat treatment at 80˜90° C. for 1˜5 min, and evaporated. For sterilization, the resultant is subjected to heat sterilization, cooled, and then mixed with maltitol and dextrose, followed by spray-drying to obtain a vegetable extract.

The vegetable extract is added to drinking water, and stirred using a stirrer for uniform dispersion and prevention of precipitation. Nitrate-reducing bacteria are added thereto, mixed and dispersed. At this time, the vegetable extract mixture is maintained and stabilized at 10˜60° C., and then mixed with nitrate-reducing bacteria, in order to facilitate the growth of nitrate-reducing bacteria. The temperature is maintained at the above range, and the mixture is fermented for 0.1˜24 hrs. When a final pH of the vegetable extract fermented solution reaches 3.0˜6.5, the solution is cooled, and stored at 10° C. or below.

In addition, the present invention provides a preparation method of meat products, comprising the steps of:

1) admixing a raw meat with a vegetable extract fermented solution and sub-materials,

2) stuffing, shaping, extruding, and heat-treating the admixture, and

3) showering, heat-releasing, and packaging the heat-treated product.

The preparation method of meat products will be described in detail below.

First, raw meats are cut into a diameter of 3˜4 mm, and trimmed or ground. The prepared raw meats, the vegetable extract fermented solution, salts, protein products such as powdered egg white, sugar, and spice are put in a blender, and mixed at low speed. After mixing at low speed, the mixture is blended at high speed under a vacuum for 5˜10 min. At this time, the vegetable extract fermented solution is added in an amount of 0.1˜50% by weight, based on the total amount of the mixture. If the content of the vegetable extract fermented solution is less than 0.1% by weight, its effect on pink color development is not desirably exhibited. If the content of the vegetable extract fermented solution is more than 50% by weight, there is no significant improvement in the color development, whereas physical properties are deteriorated not to ensure product quality. The mixture solution is stuffed using a stuffer, shaped, extruded, and heat-treated until the core temperature reaches to 72˜121° C. The heat-treated product is showered using a spray shower, and heat-released in a room until the core temperature reaches to 12˜15° C. or below. After heat-releasing, the product is packaged to produce a meat product.

When meat products are produced by using the vegetable extract fermented solution according to the present invention, the effect of color fixation on the meat products can be improved without adding synthetic nitrite to the vegetable extract fermented solution. Furthermore, when meat products are produced by using the vegetable extract fermented solution according to the present invention, 3.7 or higher score was given for the meat products in the sensory evaluation on product quality, indicating excellent customer satisfaction, and there were no significant differences in color of cross-sections of the meat product and lipid oxidation from meat products prepared by adding synthetic nitrite.

Accordingly, the vegetable extract fermented solution according to the present invention can be used as an alternative to synthetic nitrite, thereby being useful for the production of nitrite-free meat products.

Examples of the meat product include ham, bacon, sausage or the like.

### MODE FOR INVENTION

Hereinafter, the preferred examples are provided for better understanding. However, these Examples are for the illustrative purpose only, and the present invention is not intended to be limited by these Examples.

### Example 1

### Preparation of Vegetable Extract Fermented Solution

1. Preparation of Vegetable Extract

Carrots, celery, cabbage, lettuce, spinach, potatos, radish, and sugar beets were washed with water. Each 0.1 kg of the vegetables was squeezed out, and the juice was filtered. The filtrate was heat-treated at 80˜90° C. for 1˜5 min, and evaporated. Then, heat-sterilization was performed, and the resultant was cooled to 10˜30° C. Each 100 g amount of maltitol and dextrose were added to the juice and mixed, followed by spray-drying.

2. Preparation of Vegetable Extract Fermented Solution

The vegetable extract prepared in the above procedure 1 was added and dispersed into drinking water. The vegetable extract mixture was maintained at 10˜60° C., and then nitrate-reducing bacteria were added thereto, and dispersed. The temperature was maintained at the above range, and fermented for 0.1˜24 hrs. When a final pH of the vegetable extract fermented solution reached 3.0˜6.5, the solution was cooled, and stored at 10° C. or below.

### Example 2

### Production of Meat Products Using Vegetable Extract Fermented Solution of the Present Invention

1. Production of Vienna Sausage

Raw meats were cut into a diameter of 3-4 mm, and trimmed or ground. 20.0 kg of the prepared raw meat, 1.5 kg of the vegetable extract fermented solution prepared in Example 1, 0.24 kg of salts, 0.3 kg of protein products such as powdered egg white, 0.4 kg of sugar, and 0.14 kg of spice were put in a blender, and mixed at low speed. After mixing, the mixture was blended at high speed under a vacuum for 5˜10 min. The mixture solution was stuffed using a stuffer, shaped, extruded, and heat-treated until the core temperature reached to 72° C. or higher. The heat-treated product was showered using a spray shower, and heat-released in a room until the core temperature reaches to 12˜15° C. or below. After heat-releasing, the product was packaged to produce a vienna sausage.

2. Production of Round-Shaped Meat Product

A round-shaped meat product was produced in the same manner as in the above procedure 1.

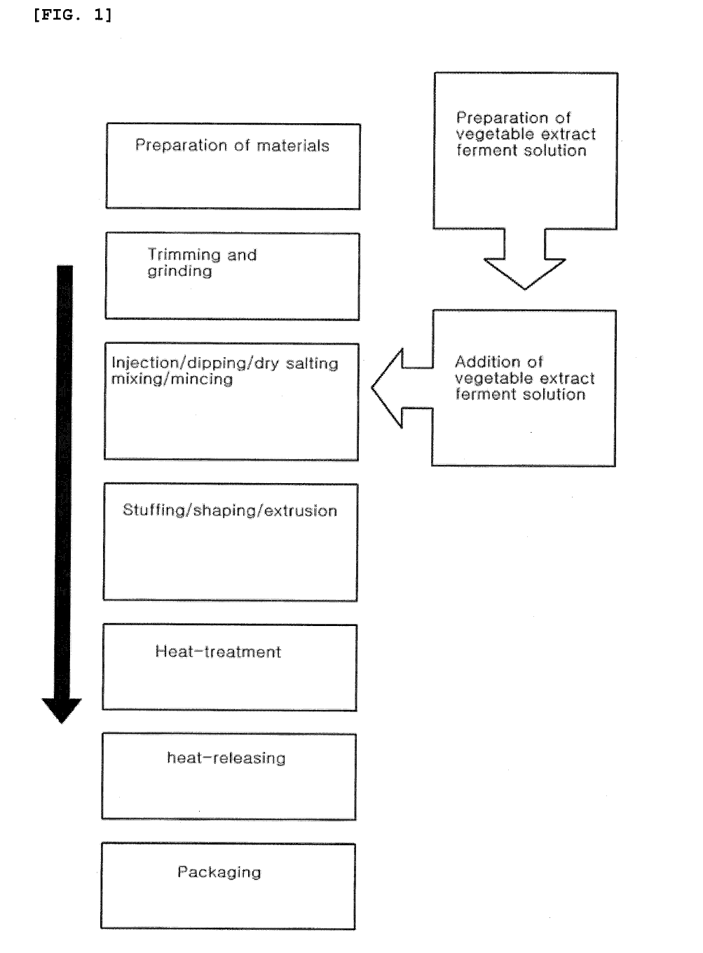

The production process of meat products using the vegetable extract fermented solution according to the present invention is shown in FIG. 1.

### Experimental Example 1

### Sensory Evaluation on Meat Products Prepared Using Vegetable Extract Fermented Solution of the Present Invention

35 women were randomly selected from 25˜49 year old-married women who reside in Seoul, and subjected to sensory evaluation on the vienna sausage and round-shaped meat product, which were prepared by using the vegetable extract fermented solution in Example 2. As a Comparative Example, the meat product prepared by adding synthetic nitrite was used.

Each item was evaluated using a 5-point scoring system (5: very good, 4: good, 3: moderate, 2: fair, 1: bad), and the results are expressed as mean values. If 3.7 or higher score was given for the items of overall taste preference and taste preference, the meat product can be marketed with high customer satisfaction.

The results of sensory evaluation on the vienna sausage prepared by using the vegetable extract fermented solution of the present invention are shown in Table 1, and the results of sensory evaluation on the round-shaped meat product prepared by using the vegetable extract fermented solution of the present invention are shown in Table 2.

TABLE 1

| | | Vegetable extract |
|---|---|---|
| | Synthetic nitrite-added | fermented solution-added |
| | vienna sausage | vienna sausage |
| Appearance | 3.99 | 3.96 |
| Overall | 3.71 | 3.94 |
| taste | | |
| preference | | |
| Flavor | 3.79 | 3.89 |
| preference | | |
| Taste | 3.77 | 3.99 |
| preference | | |
| Texture | 3.71 | 4.04 |
| preference | | |
| Aftertaste | 3.66 | 3.86 |
| preference | | |

TABLE 2

| | Synthetic nitrite-added | Vegetable extract |
|---|---|---|
| | round-shaped meat | fermented solution-added |
| | product | round-shaped meat product |
| Appearance | 3.84 | 3.78 |
| Overall | 3.87 | 3.86 |
| taste | | |
| preference | | |
| Flavor | 3.79 | 3.78 |
| preference | | |
| Taste | 3.83 | 3.91 |
| preference | | |
| Texture | 3.99 | 4.01 |
| preference | | |
| Aftertaste | 3.71 | 3.82 |
| preference | | |

As shown in Tables 1 and 2, 3.7 or higher score was provided for the vienna sausage or round-shaped meat product prepared by adding the vegetable extract fermented solution according to the present invention in the sensory evaluation.

### Experimental Example 2

### Color of Cross-Section of Meat Product Prepared by Using Vegetable Extract Fermented Solution of the Present Invention

Color examination was performed on the vienna sausage prepared by using the vegetable extract fermented solution in Example 2. As a Comparative Example, the vienna sausage prepared by adding synthetic nitrite was used.

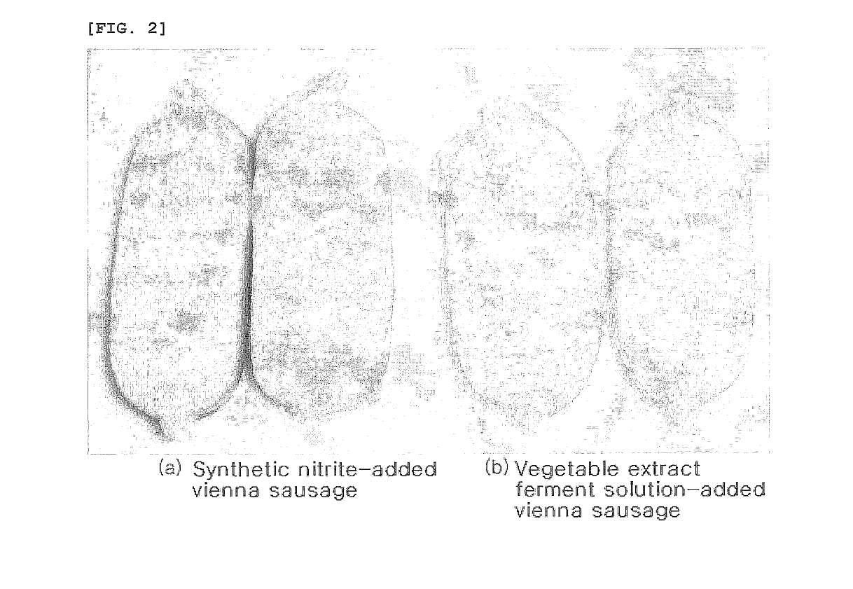

The results are shown in FIG. 2.

As shown in FIG. 2, there were no significant differences between the colors of the vienna sausage prepared by using the vegetable extract fermented solution according to the present invention and the vienna sausage prepared by adding synthetic nitrite.

### Experimental Example 3

### Evaluation of Lipid Oxidation in Meat Product Prepared by Using Vegetable Extract Fermented Solution of the Present Invention

The thiobarbituric acid (TBA) test for lipid oxidation measurements was performed, while the vienna sausages prepared by using the vegetable extract fermented solution in Example 2 were stored in a refrigerator for 15 days. As a Comparative Example, the vienna sausage prepared by adding synthetic nitrite was used.

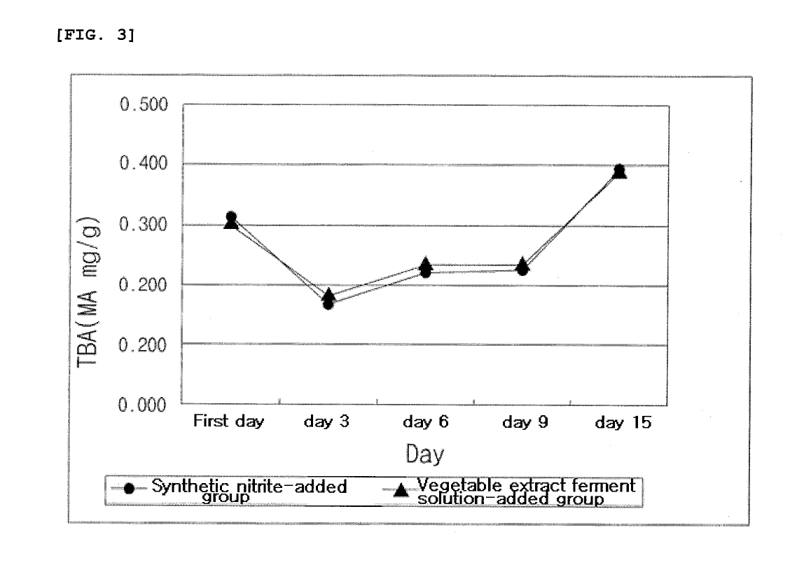

The results are shown in FIG. 3.

As shown in FIG. 3, in the TBA test, the vienna sausage prepared by using the vegetable extract fermented solution according to the present invention was found to have an antioxidant effect to inhibit lipid oxidation, and no significant difference from the vienna sausage prepared by adding synthetic nitrite. Also, its TBA value did not exceed 20 MA mg/g.

### INDUSTRIAL APPLICABILITY

The vegetable extract fermented solution prepared from nitrate-containing vegetables is used for the production of meat products to improve characteristic meat color and inhibit lipid oxidation without using synthetic nitrite.

1. A preparation method of vegetable extract fermented solution, comprising the steps of:
1) washing and squeezing vegetables, and then performing filtration, heat-treatment, and heat-sterilization of the vegetable juice,
2) mixing the sterilized vegetable juice with maltitol and dextrose, and then spray-drying the mixture to obtain a vegetable extract; and
3) mixing the vegetable extract with drinking water, adding nitrate-reducing bacterium to the vegetable extract, mixing/spraying it, and performing fermentation and cooling thereof.

2. The preparation method according to claim 1, wherein the vegetables in step 1) include carrot, celery, cabbage, lettuce, spinach, potato, radish and sugar beet.

3. The preparation method according to claim 1, wherein the heat-treatment in step 1) is performed at 80˜90° C. for 1˜5 min.

4. The preparation method according to claim 1, wherein in step 3), the fermentation is performed at 10˜60° C. for 0.1˜24 hrs, and the vegetable extract fermented solution is cooled when its final pH reaches 3.0˜6.5.

5. A vegetable extract fermented solution prepared by the method according to any one of claims 1 to 4.

6. A preparation method of meat products, comprising the steps of:
1) admixing a raw meat with the vegetable extract fermented solution of claim 5 and sub-materials,
2) stuffing, shaping, extruding, and heat-treating the admixture, and
3) showering, heat-releasing, and packaging the heat-treated product.

7. The preparation method according to claim 6, wherein the vegetable extract fermented solution in step 1) is added in an amount of 0.1-50% by weight, based on the total amount of the mixture.

8. The preparation method according to claim 6, wherein the sub-materials in step 2) include salts, protein products such as powdered egg white, sugar, and spice.

9. The preparation method according to claim 6, wherein the heat-treatment in step 2) is performed until the core temperature reaches to 72˜121° C.

10. A meat product prepared by the method according to any one of claims 6 to 9.

11. The meat product according to claim 10, wherein the meat product is one selected from ham, bacon, and sausage.
